(19) United States
(12) Patent Application Publication
(10) Pub. No.: US 2026/0078995 A1
(43) Pub. Date: Mar. 19, 2026

(54) CONTACT SYSTEMS AND METHODS

(71) Applicant: Apple Inc., Cupertino, CA (US)

(72) Inventors: Mikael B. MANNBERG, San Jose, CA (US); Sankarshan Narasimha MURTHY, Mountain View, CA (US); Prashant K. OSWAL, San Dimas, CA (US)

(21) Appl. No.: 19/333,191

(22) Filed: Sep. 18, 2025

Related U.S. Application Data
(60) Provisional application No. 63/696,101, filed on Sep. 18, 2024.

(51) Int. Cl. G01B 5/012; G01S 13/58

(52) U.S. Cl. CPC G01B 5/012; G01S 13/58

(57) ABSTRACT

In some examples, a plurality of contact members is connected to a contact base of an electronic device. The contact base and the plurality of contact members form a contact system. At least one sensor is configured to capture object data corresponding to at least one object. A relative velocity between the contact system and the object is determined based on the object data. The contact system is configured to apply a force profile to the object based on the relative velocity.

### CROSS-REFERENCE TO RELATED APPLICATIONS

The present application claims priority to U.S. Provisional Application No. 63/696,101, filed Sep. 18, 2024, which is incorporated by reference in its entirety herein.

### FIELD

Aspects of the present disclosure relate to contact systems and methods for an electronic device and more particularly to contacting an object in an environment using a contact system of an electronic device.

### BACKGROUND

In some contexts, electronic devices may have one or more components configured for manipulation relative to objects. However, manipulation of such components often involves vast amounts of training data, such that scaling to different objects and adapting to varying conditions is challenging.

### SUMMARY

Implementations described and claimed herein provide contact systems and methods. In some implementations, an object is detected in an environment. A contact system of an electronic device is moved towards the object. The contact system has a plurality of contact members connected to a contact base. A force profile is applied to the object using the contact system. The force profile is applied based on a relative velocity between the contact system and the object.

In some implementations, a plurality of contact members is connected to a contact base of an electronic device. The contact base and the plurality of contact members form a contact system. At least one sensor is configured to capture object data corresponding to at least one object. A relative velocity between the contact system and the object is determined based on the object data. The contact system is configured to apply a force profile to the object based on the relative velocity.

In some implementations, object data for an object in an environment is obtained. The object data is captured using at least one sensor of an electronic device. A relative velocity between a contact system of the electronic device and the object is measured using the object data. It is determined whether the contact system captured the object in connection with application of a force profile to the object. Capture of the object is determined based on the relative velocity between the contact system and the object.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 shows a block diagram illustrating example object contact.

FIG. 2 shows a block diagram of an example electronic device.

FIG. 3 shows a block diagram of an example electronic device.

FIG. 4 illustrates example operations for object contact.

FIG. 5 shows an example computing system configured for object contact.

### DETAILED DESCRIPTION

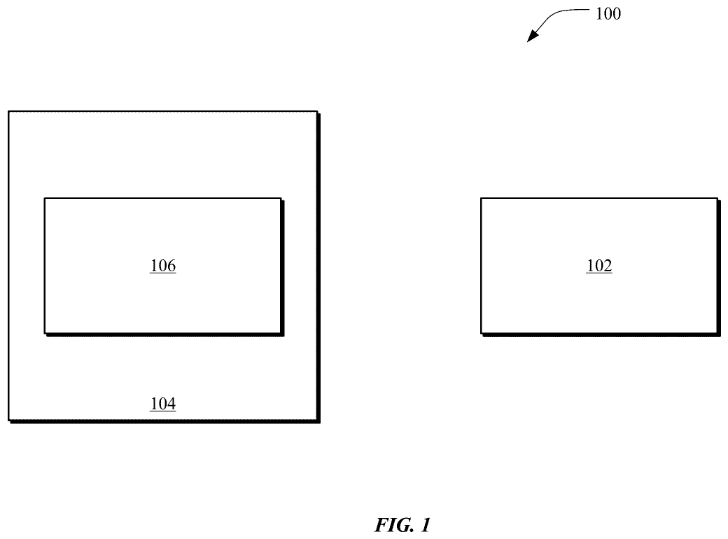

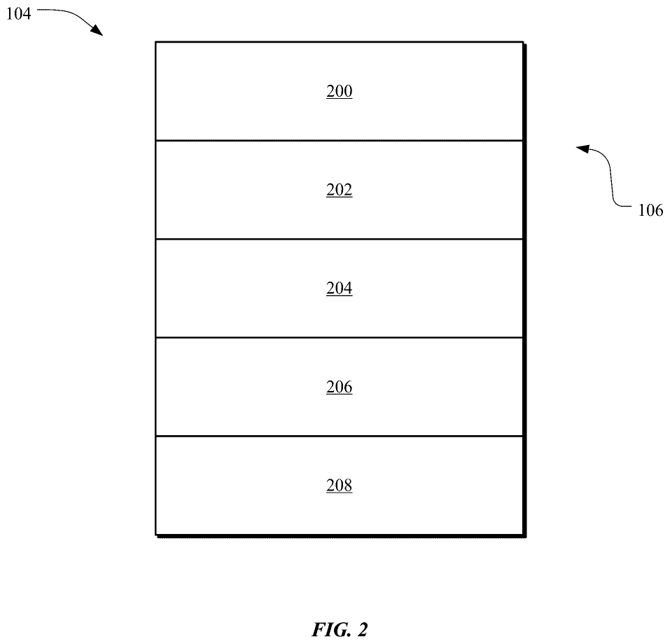

To begin a detailed description of an example environment 100 for object interaction, reference is made to FIGS. 1-2. In some implementations, an object 102 and an electronic device 104 are positioned in the environment 100. The electronic device 104 may be configured to move in various manners within the environment 100. In some examples, the electronic device 104 may be stationary with one or more movable components and/or one or more stationary components. In other examples, the electronic device 104 may be configured to move along a movement path from a first orientation to a second orientation within the environment 100 and may include one or more moveable components and/or one or more stationary components. Each of the moveable components may be configured to move along a trajectory from a first component orientation to a second component orientation.

The electronic device 104 may include a contact system 106. The contact system 106 may include one or more of such moveable and/or stationary components. In some examples, the contact system 106 includes one or more contact members 200, a contact base 202, and a base connecting member 204. The contact members 200 and the base connecting member 204 may each be connected to the contact base 202. Each of the contact members 200 and the base connecting member 204 may be configured to move independently relative to each other and/or the contact base 202. For example, each of the contact members 200, the base connecting member 204, and/or the contact base 202 may have one or more articulation portions (e.g., joint) having one or more degrees of freedom. Such degrees of freedom may include translation motion along the x-axis, the y-axis, and/or the z-axis, rotational motion about the x-axis, the y-axis, and/or the z-axis, and/or combinations thereof.

In some examples, each of the contact members 200 is connected to the contact base 202 at a corresponding articulation portion. Each of the contact members 200 may further include one or more articulation portions along a length of the contact member 200. The contact members 200 may be connected at various locations on the contact base 202. In some examples, a first contact member set of one or more of the contact members 202 and a second contact member set of one or more of the contact members 202 are connected to the contact base 202 relative to each other. The first contact member set may be positioned at a first area of the contact base 202 and the second contact member set may be positioned at a second area of the contact base 202 that is different from the first portion. The first contact member set and the second contact member set may be positioned in an opposing relationship, such that the first contact member set and the second contact member set are configured to articulate towards each other. In some examples, the base connecting member 204 connects the contact base 200 with a base member 206, which is connected to a base 208. The base member 206 may connect with the base 208 at an articulation portion having one or more degrees of freedom for moving the contact system 106. Such degrees of freedom may include translation motion along the x-axis, the y-axis, and/or the z-axis, rotational motion about the x-axis, the y-axis, and/or the z-axis, and/or combinations thereof. The base member 206 may further have one or more articulation portions between the base 208 and the base member 206 with one or more degrees of freedom.

The contact system 106 may include a proximal region, a middle region, and a distal region. The contact members 202 may be disposed in the distal region, the contact base 200 may be disposed in the middle region, and the base connecting member 204 may be disposed in the proximal region. In some examples, the proximal region may control length-tension relationships to provide fine contact adjustment and/or movement of the contact system 106 relative to the object 102, as well as to collectively move the middle and the distal portions of the contact system 106 to different positions and/or orientations in space. The distal region provides one or more member surfaces to provide contact with the object 102 at one or more locations on the object 102, as well as to articulate the object 102 towards one or more base surfaces of the contact base 200 for capture. The member surfaces may have a smaller size relative to the base surfaces. In this manner, the object 102 may be stabilized by the distal region against the middle region of the contact system 106 during capture.

In some examples, the contact system 106 is an end effector that is configured to interact with objects through contact (e.g., manipulation, moving, gripping, grasping, exploring, controlling, capturing, etc.). Contact with objects often involves a considerable number of sensors (e.g., force, vision, etc.) combined with machine learning techniques, particularly to determine whether an object has been captured. For example, capture of an object is nuanced, involving enough force applied to securely move the object but not so much that the object is crushed or so little that the object slips. Typically, such a complex objective involves vast amounts of training data, especially in accounting for different object types, environment conditions, object characteristics, and/or the like. Accordingly, the electronic device 104 improves object detection, understanding, and interaction through contact systems and methods using the contact system 106. More particularly, in some implementations, the electronic device 104 articulates the contact system 106 and detects that the object 102 is captured by the contact system 106 when a relative velocity between the object 102 and the contact system 106 matches a threshold, such as zero. With the relative velocity matching the threshold, the object 102 is in a captured state (e.g., the object 102 and the contact system 106 are moving together, the object 102 is rigidly following movement of at least a portion of the electronic device 104 (e.g., the contact base 202) through space, etc.). If the relatively velocity between object 102 and the contact system 106 does not match the threshold (e.g., is non-zero), the electronic device 104 determines that the object 102 is outside of a captured state, such as partially captured (e.g., slipping) or uncaptured. Thus, the electronic device 104 provides accurate detection of object capture while eliminating complex sensors and complex training data.

In other words, the presently disclosed technology generally provides contact systems and methods. In some implementations, the electronic device 104 is configured to contact one or more objects, such as the object 102, in various manners using the contact system 106. For example, the contact system 106 may capture the object 102 in the environment 100. Sensor(s) associated with the electronic device 104 (e.g., positioned at the contact system 106, elsewhere on the electronic device 104, and/or external to the electronic device 104) may capture object data for the object 102. Using the object data, a relative velocity between the contact system 106 and the object 102 is measured. The contact system 106 applies a force profile including one or more forces at corresponding location(s) of the object 102. The electronic device 104 determines whether the contact system 106 captured the object 102 based on the relative velocity between the contact system 106 and the object 102. In some examples, the relative velocity is measured a plurality of times in connection with a capture action and application of the force profile is dynamically adjusted accordingly. The electronic device 104 may determine that the object 102 is captured when the relative velocity matches a threshold, such as having a zero value. Stated differently, the object 102 may be in state other than a captured state (e.g., a partially captured state or uncaptured state) if the relative velocity is different than the threshold (e.g., non-zero value(s)). Accordingly, the presently disclosed technology facilitates and improves interaction between electronic devices and object(s) by providing contact system and methods configured to capture and manipulate different types of object(s) with various characteristics and within varying environmental conditions.

In some examples, the relative velocity between the object 102 and the contact system 106 may be captured in connection with movement of one or more portions of the electronic device 104 (e.g., movement of the contact system 106). In some examples, the relative velocity is captured at a plurality of times (e.g., continuously during movement, at regular intervals, at predetermined times, etc.). Based on the relative velocity, the contact system 106 applies a force profile having one or more forces at one or more locations to the object 102. The force profile may be dynamically adjusted to maintain the relative velocity at the threshold (e.g., zero). More particularly, if the electronic device 104 detects that the relative velocity is outside the threshold (e.g., non-zero), the force profile applied by the contact system 106 is dynamically adjusted.

As described in more detail herein, the relative velocity may be measured directly and/or indirectly using several different sensing modalities. For example, Frequency-Modulated Continuous Wave (FMCW) Light Detection and Ranging (LIDAR) data, radar data, and/or other sensor data may be used to determine the relative velocity between the object 102 and the contact system 106. FMCW-LIDAR data may provide range and velocity per point with multiple points on the object 102, thereby generating rotation and angular velocity measurements, as well as position and linear velocity measurements of the object 102. Stated differently, the FMCW-LIDAR data may include position and relative velocity of each point in a point cloud corresponding to at least the object 102. In this manner, the electronic device 300 can detect if the object 102 moves within the contact system 106, as well as if the object moves 102 outside of the contact system 102. Radar data may provide a velocity of each of the object 102 and the contact system 106, independent of position of the contact system 106 (e.g., without concern for sensor occlusion). In some examples, the object 102 may have one or more portions moving relative to the capture system 106, such that the relative velocity at certain points does not match the threshold, but the object 102 remains in a captured state. Object data, including FMCW-LIDAR data, radar data, and/or other sensor data corresponding to the object 102 and/or the environment 100 may be used to determine relative velocity, object type, object characteristics (e.g., rigidity, surface texture, surface condition, object composition, object orientation, etc.) environmental conditions, and/or the like. Using such object data, the electronic device 104 controls interaction with the object 102 through contact, including determining whether the object 102 is captured by the contact system 106.

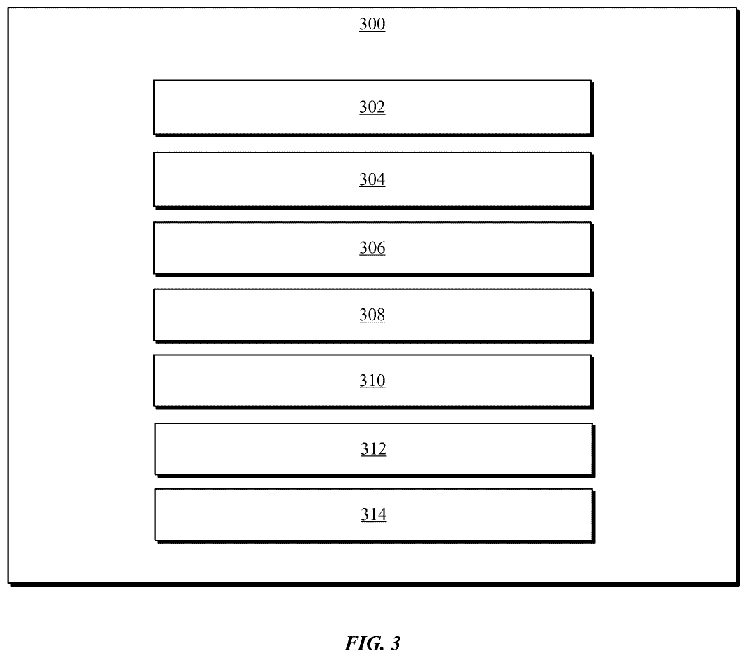

Turning to FIG. 3, an example electronic device 300, which may be the electronic device 104 and/or other electronic devices, is shown. In some implementations, the electronic device 300 includes a sensor system 302 and device systems. It will be appreciated that any of a perception system 304, a planning system 306, a control system 308, subsystems 310, an interface system 312, and/or a communication system 314 may be part of or separate from the device systems. The subsystems 310 may include the contact member(s) 200, the contact base 202, the base connecting member 204, the base member 206, the base 208, systems corresponding to moveable and/or stationary components, and/or other systems executing operation(s) of the electronic device 300.

The sensor system 302 includes one or more sensors configured to capture object data, including, but not limited to: data of a field of view of the electronic device 300 and/or one of more of the subsystems 310; data corresponding to the relative velocity of the contact system 106 and the object 102 (e.g., FMCW-LIDAR data, radar data, etc.); localization data corresponding to a location, heading, and/or orientation of the electronic device 300 and/or one of more of the subsystems 310; movement data corresponding to motion of the electronic device 300 and/or one or more of the subsystems 310; and/or data corresponding to the object 102 and/or an environment in which the object 102 and the electronic device 300 are located. The one or more sensors of the sensor system 302 may include, without limitation, three-dimensional (3D) sensors configured to capture 3D images, two-dimensional (2D) sensors configured to capture 2D images, FMCW-LIDAR sensors, radar sensors, infrared (IR) sensors, optical sensors, and/or visual detection and ranging (ViDAR) sensors. For example, the one or more 3D sensors may include depth sensors configured to capture depth maps, point cloud data and/or other 3D data, and the one or more 2D sensors may include cameras (e.g., RGB cameras) configured to capture color images, grayscale images, and/or other 2D images.

The sensor system 302 may include a localization system configured to capture localization and/or movement data. The localization systems may include, without limitation, a Global Navigation Satellite System (GNSS), inertial navigation system (INS), inertial measurement unit (IMU), global positioning system (GPS), altitude and heading reference system (AHRS), compass, and/or accelerometer. The sensor system 302 may include other sensors to capture localization data, movement data, relative velocity, and/or other object data. For example, the sensor system 302 may include one or more sensors configured to capture sensor data corresponding to the object 102 and/or an environment in which the object 102 and the electronic device 300 are located.

The sensor(s) of the sensor system 302 may be positioned at various locations of the electronic device 300. For example, sensor(s) of the sensor system 302 may be positioned at the contact system 106, at other locations on the electronic device 300, and/or at locations external to the electronic device 300. In some examples, the sensor system 302 includes a FMCW-LIDAR sensor positioned at the contact system 106 (e.g., the contact base 202). Alternatively or additionally, the sensor system 302 may include a radar sensor positioned at various locations on the electronic device 300. The FMCW-LIDAR sensor provides object data with a plurality of points on the object 102, measuring rotation and angular velocity, as well as position and linear velocity of the object 102, while the radar sensor detects object data through the contact system 106 and/or other components of the electronic device 300, such that velocity of both the contact system 106 and the object 102 is captured regardless of where the radar sensor is positioned on the electronic device 300.

The perception system 304 may generate perception data, which may detect, identify, classify, and/or determine position(s) of one or more objects, such as the object 102, using the object data. The perception system 304 may further generate perception data corresponding to an orientation of the subsystems 310 (e.g., the contact member(s) 200, the contact base 202, the base connecting member 204, the base member 206, the base 208, etc.) and/or the electronic device 300 relative to each other, the object 102, and/or other structures within the environment in which the electronic device 300 and the object 102 are located. For example, using the relative velocity, the electronic device 300 may determine whether the object 102 is captured by the contact system 106, and object data and/or perception data may be used to determine object type, object characteristics (e.g., rigidity, surface texture, surface condition, temperature, object composition, object orientation, etc.) environmental conditions, and/or the like. Additionally, using the object data and/or the relative velocities between the contact system 106 and/or other portions of the electronic system 300, a touch map of the environment in which the electronic device 300 is located may be generated, such that the electronic device 300 generates an understanding of how the electronic device 300 and/or portions and/or the subsystems 310 of the electronic device 300 are moving and/or contacting various structures in the environment, such as the object 102 and other objects or physical structures. Using the touch map, the electronic device 300 can interact with such structures within the environment through contact in precise manners with rapid response, while having a tactile sensory input for such interactions.

The relative velocity, perception data, and/or the object data may be used by the planning system 306 in generating one or more actions for the electronic device 300, such as generating a force profile including one or more forces for application at one or more locations to the object 102, dynamically adjusting the force profile, generating a movement plan having at least one movement action for moving the electronic device 300 and/or one or more of the subsystems 310 along a movement path from a first orientation and/or position to a second orientation and/or position.

The control system 308 may be used to control various operations of the electronic device 300, including, but not limited to, applying the force profile using the contact system 106, adjusting the force profile, moving the electronic device 300, moving one or more of the subsystems 310, interacting with the object 102, interacting with a user, and/or other operations. Motion plans for moving the electronic device 300 and/or one or more of the subsystems 310 (e.g., moving the contact system 106 to apply the force profile) may include various operational instructions for the subsystems 310 of the electronic device 300 to execute to perform corresponding movement action(s), as well as other action(s). In some examples, the electronic device 300 moves on its own planning and decisions. Instructions for operating the electronic device 300 may be executed by the planning system 306, the control system 308, the subsystems 310, and/or other components of the electronic device 300. The instructions may be modified prior to execution by the electronic device 300 (e.g., using the interface system 312 and/or input from a user device in communication with the electronic device 300 via the communication system 314), and in some cases, the electronic device 300 may disregard the instructions according to its own planning and decisions, for example, based on the object data captured by the sensor system 302.

In some implementations, the interface system 312 includes a presentation system and an input system. The input system of the interface system 312 may include one or more input devices configured to capture various forms of user input. For example, the interface system 312 may be configured to capture visual input (e.g., information provided via gesture), audio input (e.g., information provided via voice), tactile input (e.g., information provided via touch, such as via a touch-sensitive display screen (“touchscreen”), etc.), device input (e.g., information provided via one or more input devices), and/or the like from a user and/or other electronic devices. Similarly, the presentation system of the interface system 312 may include one or more output devices configured to present output data in various forms, including visual (e.g., via display, projection, etc.), audio, and/or tactile. The interface system 312 may include various software and/or hardware for input and presentation. The input system and the presentation system may be integrated into one system, in whole or part, or separate. For example, the input system and the presentation system of the interface system 312 may be provided in the form of a touchscreen.

In some implementations, the interface system 312 provides an interactive interface. The interactive interface may be deployed on, remote from, and/or in a vicinity of the electronic device 300. In some examples, the interface system 312 may be provided via an instrument panel, such as interactive dashboard having a touchscreen, a heads-up-display, and/or a user device in communication with the interface system 312 via the communication system 314 to control and/or interact with the electronic device 300, the object 102, and/or the environment in which the electronic device 300 is located. The communication system 314 may include, without limitation, one or more antennae, receivers, transponders, transceivers, and/or communication ports. In some cases, the communication system 314 includes a first communication system and a second communication system that have different hardware and/or software for communicating using different communication protocols and/or via different types of wireless networks. In some examples, the communication system 314 is configured for long-range communication (e.g., via cellular network, satellite network, radio, etc.), short-range communication (e.g., Bluetooth, Wi-Fi, UWB, etc.) and/or to otherwise communicate with various computing devices via wired and/or wireless connection.

In some implementations, the electronic device 300 detects the object 102 in the environment, and the contact system 106 may move relative to (e.g., towards, along, about, away from, and/or so forth) the object 102. For example, the perception system 304 may detect the object 102 using object data, the planning system 306 may generate one or more movement actions to move the contact system 106 relative to the object 102, and the control system 308 may control one or more operations to execute the movement actions. The contact system 106 may be moved by moving the contact members 200, the contact base 202, the base connecting member 204, the base member 204, the base 206, the electronic device 300, and/or combinations thereof to position the contact system 106 to contact the object 102 for capture.

The electronic device 300 may generate a force profile using the object data and apply the force profile to the object 102 using the contact system 106. In some examples, the force profile is applied based on a relative velocity between the contact system 106 and the object 102. The force profile may be further generated and applied based on an object profile for the object. The object profile may be determined based on the object data captured by the sensor system 202 and/or other input provided via the interface system 312 and/or an external device in communication with the electronic device 300 via the communication system 314. The object profile includes one or more characteristics of the object 102, such as rigidity, fragileness, hardness, thickness, surface texture (e.g., smooth, rough, irregular, openings, etc.), surface condition (e.g., wet, slippery, low friction, etc.), object type, object composition (e.g., materials, etc.), object orientation, object size, object shape, temperature, and/or so forth.

In some examples, the contact system 106 applies the force profile by distributing one or more forces onto the object 102 at one or more locations using the contact members 200 and/or the contact case 202. The electronic device 300 may determine the relative velocity between the contact system 106 and the object 102 at one or more times during a capture action, as well as following the capture action to confirm that the object 102 is maintained in a captured state. The electronic device 300 may determine that the object 102 reaches or is maintained in the captured state when the relative velocity matches a threshold, such as zero. The force profile may be dynamically adjusted. For example, if the object 102 is outside of the captured state (e.g., particularly captured or uncaptured), such that the relative velocity does not match the threshold (e.g., is non-zero), the force profile may be adjusted until the threshold is met and the object 102 is in the captured state. In some instances, the relative velocity may not match the threshold, but the electronic device 300 may determine that the object 102 is in the captured state using the object data (e.g., other sensor data, user input, etc.). For example, if the relative velocity is within a buffer of the threshold, the electronic device 300 may perform a capture validation to determine if the object 102 is in the captured state. In another example, if the relative velocity of a designated portion of the object 102 (e.g., a center of mass, center of gravity, etc.) has a relative velocity matching the threshold, the object 102 may be determined to be in the captured state, even if other portions of the object 102 have points that have a relative velocity that does not match the threshold. In this manner, the electric device 300 may not need to understand the relative velocity of each point of the object 102, but instead can obtain the relative velocity for one or more designated points to determine if the object 102 is captured.

The force profile includes one or more forces. In some examples, the force profile includes a first force set and a second force set, with the first force set including one or more first forces, and the second force set including one or more second forces. The first force set and the second force set may have one or more forces with different magnitudes within the sets and/or compared with each other. The second force set may be applied after the first force set, for example, as an adjustment in response to application of the first force set. The second force set may be applied with the relative velocity does not match the threshold and/or the object 102 is not in the captured state following application of the first force set. The relative velocity may be determined based on an angular velocity, a linear velocity, and/or combinations thereof of the object 102 relative to the contact system 106. In some examples, a first velocity of the contact system 106 and a second velocity of the object 102 are directly measured in determining the relative velocity.

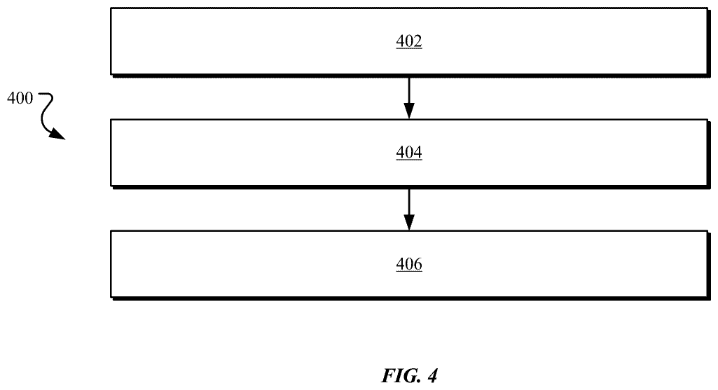

Turning to FIG. 4, example operations 400 for object contact are illustrated. In some implementations, an operation 402 obtains object data for an object in an environment. The object data may be captured using at least one sensor of an electronic device. A contact system may be moved relative to the object for capture. An operation 404 measures a relative velocity between the contact system and the object using the object data captured by the at least one sensor. An operation 406 generates a determination of whether the contact system captured the object in connection with application of a force profile to the object. The operation 406 determines whether the object is captured based on the relative velocity between the contact system and the object. For example, capture of the object may be determined based on whether the relative velocity between the contact system and the object matches a threshold (e.g., whether the relative velocity is zero or non-zero). The operation 404 may measure the relative velocity at a plurality of times (e.g., continuously, intervals, based on feedback from the sensor(s), etc.) in connection with a capture action (e.g., during, after, etc.), and the operation 406 may determine at each of the plurality of times whether the object is in a captured state. The force profile may be dynamically adjusted based on the relative velocity. Additionally, in some instances, an object profile is generated, and the force profile is further generated based on the object profile.

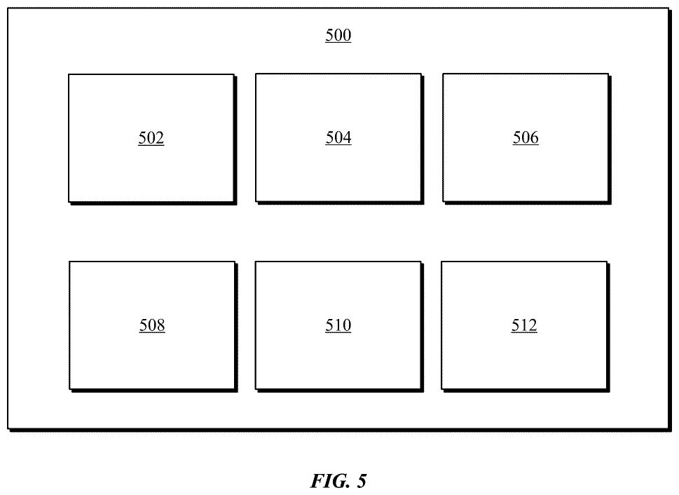

Referring to FIG. 5, a detailed description of an example computing device 500 having one or more computing units that may implement various systems and methods discussed herein is provided. Various components of the computing device 500 can be formed into a specific, non-conventional, and non-generic arrangement to achieve the various technological solutions discussed herein. As such, the computing device 500 and/or components of the computing device 500 may be applicable to the electronic device 104, the contact system 106, the electronic device 300, various systems and subsystems of the electronic device 300, and/or other computing or network devices. In some examples, the electronic device 104 and/or the electronic device 300 are robots, machines, security systems, home systems, user devices, and/or so forth, but it will be appreciated that these devices may be various types of electronic devices. It will be appreciated that specific implementations of these devices may be of differing possible specific computing architectures not all of which are specifically discussed herein but will be understood by those of ordinary skill in the art.

The computing device 500 may be a computing system capable of executing a computer program product to execute a computer process. Data and program files may be input to the computing device 500, which reads the files and executes the programs therein. Some of the elements of the computing device 500 are shown in FIG. 5, including one or more hardware processor(s) 502, one or more data storage device(s) 504, one or more memory device(s) 506, and/or one or more port(s) 508-512. Additionally, other elements that will be recognized by those skilled in the art may be included in the computing device 500 but are not explicitly depicted in FIG. 5 or discussed further herein. Various elements of the computing device 500 may communicate with one another by way of one or more communication buses, point-to-point communication paths, or other communication means not explicitly depicted in FIG. 5.

The processor 502 may include, for example, a central processing unit (CPU), a microprocessor, a microcontroller, a digital signal processor (DSP), and/or one or more internal levels of cache. There may be one or more processors 502, such that the processor 502 comprises a single central-processing unit, or a plurality of processing units capable of executing instructions and performing operations in parallel with each other, commonly referred to as a parallel processing environment.

The computing device 500 may be a conventional computer, a distributed computer, or any other type of computer, such as one or more external computers made available via a cloud computing architecture. The presently described technology is optionally implemented in software stored on the data stored device(s) 504, stored on the memory device(s) 506, and/or communicated via one or more of the ports 508-512, thereby transforming the computing device 500 in FIG. 5 to a special purpose machine for implementing the operations described herein. Examples of the computing device 500 include personal computers, servers, purpose-built autonomy processors, terminals, workstations, mobile phones, tablets, laptops, and so forth.

The one or more data storage devices 504 may include any non-volatile data storage device capable of storing data generated or employed within the computing device 500, such as computer executable instructions for performing a computer process, which may include instructions of both application programs and an operating system (OS) that manages the various components of the computing device 500. The data storage devices 504 may include, without limitation, magnetic disk drives, optical disk drives, solid state drives (SSDs), flash drives, so forth. The data storage devices 504 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and so forth. Examples of non-removable data storage media include internal magnetic hard disks, SSDs, and so forth. The one or more memory devices 506 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 504 and/or the memory devices 506, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 500 includes one or more port(s), such as an input/output (I/O) port(s) 508, communication port(s) 510, and sub-systems port(s) 512, for communicating with other computing, network, or electronic devices. It will be appreciated that the ports 508-512 may be combined or separate and that more or fewer ports may be included in the computing device 500.

The I/O port 508 may be connected to an I/O device, or other device, by which information is input to or output from the computing device 500. Such I/O devices may include, without limitation, one or more input devices, output devices, and/or environment transducer devices.

In one implementation, the input devices (e.g., one or more sensors of the sensor system 302) convert a human-generated signal, such as, human voice, physical movement, physical touch or pressure, so forth, into electrical signals as input data into the computing device 500 via the I/O port 508. Similarly, the output devices may convert electrical signals received from computing device 500 via the I/O port 508 into signals that may be sensed as output by a user, such as sound, light, and/or touch. The input device may be an alphanumeric input device, including alphanumeric and other keys for communicating information and/or command selections to the processor 502 via the I/O port 508. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, so forth. In some implementations, the input device and the output device may be the same device, for example, in the case of a touchscreen.

The environment transducer devices convert one form of energy or signal into another for input into or output from the computing device 500 via the I/O port 508. For example, an electrical signal generated within the computing device 500 may be converted to another type of signal, and/or vice-versa. In one implementation, the environment transducer devices sense characteristics or aspects of an environment local to or remote from the computing device 500. Further, the environment transducer devices may generate signals to impose some effect on the environment either local to or remote from the example computing device 500.

In one implementation, a communication port 510 is connected to a network by way of which the computing device 500 may receive network data useful in executing the methods and systems set out herein as well as transmitting information and network configuration changes determined thereby. Stated differently, the communication port 510 connects the computing device 500 to one or more communication interface devices configured to transmit and/or receive information between the computing device 500 and other devices by way of one or more wired or wireless communication networks or connections. Examples of such networks or connections include, without limitation, Universal Serial Bus (USB), Ethernet, Wi-Fi, Bluetooth, Near Field Communication (NFC), cellular, and so on. One or more such communication interface devices may be utilized via the communication port 510 to communicate one or more other machines, either directly over a point-to-point communication path, over a wide area network (WAN) (e.g., the Internet), over a local area network (LAN), over a cellular (e.g., third generation (3G), fourth generation (4G) network, or fifth generation (5G)), network, or over another communication means. Further, the communication port 510 may communicate with an antenna for electromagnetic signal transmission and/or reception. In some examples, an antenna may be employed to receive Global Positioning System (GPS) data to facilitate determination of a location of the electronic device and/or its subsystems.

The electronic devices discussed herein may include a robotic device. The computing device 500 may include the sub-systems port 512 for communicating with one or more systems to control an operation of the robotic device and/or exchange information between the computing device 500 and one or more subsystems of the robotic device. Examples of such sub-systems, include, without limitation, imaging systems, radar, LIDAR, motor controllers and systems, battery control, energy storage systems or controls, motor systems, processors and controllers, steering systems, stopping systems, light systems, navigation systems, environment controls, entertainment systems, and so forth.

The present disclosure recognizes that participation in object control may be used to the benefit of users. Entities implementing the present technologies should comply with established privacy policies and/or practices that meet or exceed industry or governmental requirements for maintaining the privacy and security of data being obtained and/or communicated. The present disclosure contemplates that computing devices participating in the object control such as the electronic device 104, would provide input interfaces for specifying when, where, and what types of communications are to occur, thereby permitting users to customize their intended functionality. Moreover, users should be allowed to opt-in or opt-out of allowing a device to participate in such services. In addition, particular information that is being communicated and/or obtained can be encrypted, structured, and/or coded to further maintain privacy and security. Third parties can evaluate these implementers to certify their adherence to established privacy policies and practices.

The system set forth in FIG. 5 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented. The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer).

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular examples. Functionality may be separated or combined in blocks differently in various implementations of the disclosure or described with different terminology. These and other variations, modifications, additions, and improvements may fall within the scope of the disclosure as defined in the claims that follow.

What is claimed is:

1. A system comprising:
a contact base of an electronic device;
a plurality of contact members connected to the contact base, the contact base and the plurality of contact members forming a contact system; and
at least one sensor configured to capture object data corresponding to at least one object, wherein a relative velocity between the contact system and the object is determined based on the object data, the contact system configured to apply a force profile to the object based on the relative velocity.

2. The system of claim 1, wherein the object is determined to be captured by the contact system when the relative velocity matches a threshold value.

3. The system of claim 1, wherein the force profile includes a first force set and a second force set, the first force set including one or more first forces and the second force set including one or more second forces, the second force set being applied after than the first force set.

4. The system of claim 3, wherein the second force set is an adjustment in response to application of the first force set.

5. The system of claim 4, wherein the contact system applies the second force set when the relative velocity is non-zero following the application of the first force set.

6. The system of claim 1, wherein the relative velocity is determined based on an angular velocity of the object relative to the contact system.

7. The system of claim 1, wherein the relative velocity is determined based on a linear velocity of the object relative to the contact system.

8. The system of claim 1, wherein a first velocity of the contact system and a second velocity of the object are directly measured in determining the relative velocity.

9. The system of claim 1, wherein the at least one sensor is positioned at the contact base.

10. The system of claim 1, wherein each of the plurality of contact members is configured to independently move relative to each other and the contact base.

11. A method comprising:
detecting an object in an environment;
moving a contact system of an electronic device towards the object, the contact system having a plurality of contact members connected to a contact base; and
applying a force profile to the object using the contact system, the force profile applied based on a relative velocity between the contact system and the object.

12. The method of claim 11, wherein the force profile is further applied based on an object profile for the object.

13. The method of claim 12, wherein the object profile includes at least one of rigidity, surface texture, object type, surface condition, object composition, or object orientation.

14. The method of claim 11, wherein the object is determined to be captured by the contact system when the relative velocity matches a threshold value.

15. The method of claim 11, wherein the force profile is distributed onto the object at a plurality of locations using the plurality of contact members.

16. One or more tangible non-transitory computer-readable storage media storing computer-executable instructions for performing a computer process on a computing system, the computer process comprising:
obtaining object data for an object in an environment, the object data captured using at least one sensor of an electronic device;
measuring a relative velocity between a contact system of the electronic device and the object using the object data; and
generating a determination of whether the contact system captured the object in connection with application of a force profile to the object, wherein capture of the object is determined based on the relative velocity between the contact system and the object.

17. The one or more tangible non-transitory computer-readable storage media of claim 16, wherein the capture of the object is determined based on whether the relative velocity between the contact system and the object is non-zero.

18. The one or more tangible non-transitory computer-readable storage media of claim 16, wherein the relative velocity is continuously measured in connection with a capture action of the electronic device.

19. The one or more tangible non-transitory computer-readable storage media of claim 16, further comprising:
generating an object profile of the object, the force profile determined based on the object profile.

20. The one or more tangible non-transitory computer-readable storage media of claim 16, further comprising:
dynamically adjusting the application of the force profile based on the relative velocity.
